(19) United States
(12) Patent Application Publication
(10) Pub. No.: US 2010/0298489 A1
(43) Pub. Date: Nov. 25, 2010

(54) FLAME-RESISTANT SEALING MATERIAL

(75) Inventor: Alexander Schoenburg-Hartenstein, Aigen-voglhub (AT)

Correspondence Address: Gregory A. Nelson;Novak Druce & Quigg LLP, 525 Okeechobee Blvd, Suite 1500, West Palm Beach, FL, 33401, US

(73) Assignee: Kreidewerk Josef Ramsauer KG, Aigen-voglhub (AT)

(21) Appl. No.: 12/679,845

(22) PCT Filed: Sep. 25, 2008
(86) PCT No.: PCT/EP2008/062877

§ 371 Date: Jun. 9, 2010

(30) Foreign Application Priority Data
Sep. 26, 2007 (EP) 07018909.7

(51) Int. Cl. C08L 83/04

(52) U.S. Cl. 524/588; 525/451

(57) ABSTRACT

The present invention concerns a composition obtained by mixing
a) a polymer of general formula 1,

R¹ₙR²₃₋ₙSi(CR³R⁴)ₘ—(O—CR³R⁴—CR⁵R⁶)ₒ—O—(CR³R⁴)ₘSiR¹ₙR²₃₋ₙ (1),
where
R¹ and R² are selected independently of one another from the group consisting of alkyl groups with between 1 and 8 carbon atoms and alkyloxy groups with between 1 and 8 carbon atoms,
n is a number between 0 and 3,
R³, R⁴, R⁵ and R⁶ are selected independently of one another from the group consisting of hydrogen and alkyl groups with between 1 and 8 carbon atoms,
m is a number between 0 and 10 and
o is a number between 1 and 1,000,
and the polymer of general formula 1 has optionally been modified with acrylic acid,
b) a metal, a compound or a complex from the group of platinum metals,
c) a condensation catalyst, and
d) a hardening agent.

The present invention concerns flame retardant compositions which can be used as sealants, and a method for the production thereof.

The sealants of the present invention contain silane modified copolymers, having one or more hydrolysable and silicon-bonded group(s) (silyl groups) at their chain ends. These react upon admission of moisture and form elastomers with crosslinkers under the influence of catalysts. Two (or more) such terminal moieties result in the cross-linking of the sealant. During cross-linking, elastomers result, which have a broad application, for example as adhesives, plugging agents or sealants.

In the state of the art organopolysiloxane masses are known which essentially contain organooxy-group terminated organopolysiloxanes, catalysts and if necessary additives.

In DE 197 57 308 A1 elastomers are disclosed which cross-link through the splitting of alcohols into organopolysiloxane masses. Here an HO-terminated organopolysiloxane reacts in the presence of a suitable catalyst with an alkoxysilane having at least three alkoxy groups and/or the partial hydrolysate thereof. The cross-linking process is odour-less, since environment-friendly alcohols are released as the fission products.

DE 43 41 136 C2 discloses organopolysiloxane masses which can be cross-linked to form flame-retardant elastomers. The starting material used is an organopolysiloxane with at least 2 SiC-bonded, aliphatically converted hydrocarbon residues per molecule, as well as other inorganic fillers and oganopolysiloxane. DE 43 41 136 C2 discloses the use of an organopolysiloxane only as a prepolymer.

However, in the state of the art a need arises to provide polyether elastomers otherwise used as sealants, having terminal silyl groups providing them with a functionality that allows them in the presence of moisture and alkoxysilanes to cross-link to form an elastomer, with flame retardance, since the elastomers known in the state of the art are easily flammable. Because of their chemical structure, the abovementioned sealing masses are normally referred to as hybrids, since they have a polyether chain in combination with silyl terminal moieties.

Sealants made from such hybrids have very good properties, but these sealants cannot be used in areas in which flame retardance sealants are called for. So there is a need in the state of the art to modify the known sealants to make them flame retardant.

A technical object for the present invention is therefore to modify sealants containing silyl terminal moiety-modified polyether, so that elastomers made from these are flame retardant, and also to provide a method for the manufacture thereof.

The technical object for the present invention is achieved by a composition obtained by mixing
a) a polymer of the general formula 1

R¹ₙR²₃₋ₙSi(CR³R⁴)ₘ—(O—CR³R⁴—CR⁵R⁶)ₒ—O—(CR³R⁴)ₘSiR¹ₙR²₃₋ₙ (1),
where R¹ and R² are selected independently of one another from the group consisting of alkyl groups with between 1 and 8 carbon atoms and alkyloxy groups with between 1 and 8 carbon atoms,
n is a number between 0 and 3,
R³, R⁴, R⁵ and R⁶ are selected independently of one another from the group consisting of hydrogen and alkyl groups with between 1 and 8 carbon atoms,
m is a number between 0 and 10 and
o is a number between 1 and 1,000,
where the polymer of general formula 1 has preferably been modified with acrylic acid,
b) a metal, a compound or a complex from the group of platinum metals,
c) a condensation catalyst, and
d) a hardening agent,
wherein the composition is obtained (i) through the addition of further components or (ii) without the addition of components.
It will be clear to a person skilled in the art, of course, that where a variable in formula 1 is indicated a number of times (R¹, R², R³, R⁴) the significance of each variable with the same notation can be different from the other variables with the same notation. However, variables with the same notation preferably have the same significance.
According to the invention an inventive composition is preferred which is obtained by the mixing described above, wherein following mixing of components a and b homogenisation takes place. The homogenisation preferably takes place over a period of at least one hour, more preferably over a period of at least 6 to 48 hours.
Particular preference is for the homogenisation to take place at ambient temperature simply by leaving to stand. In this case it is preferred that the homogenisation takes place for twelve hours or more, more preferable is a homogenisation for twenty hours or more, and particularly preferable is a homogenisation for 24 hours or more. Preferred upper limits for the duration of homogenisation in this case are 48 hours, more preferably 40 hours and particularly preferably 30 hours.
In the composition; in relation to the total weight of the composition, preferably up to 99.99% by weight and more preferably between 50 and 99.9% by weight of the polymer of formula 1 are added. Alternatively by preference between 15 and 49% by weight of the polymer of formula 1 are added, particularly preferably between 20 and 40% by weight, in each case in relation to the total weight of the composition.
The metal, compound or complex from the group of platinum metals, in relation to the total weight of the composition, is preferably contained in the composition in a proportion of between 0.001 and 1.0% by weight, preferably between 0.001 and 0.5% by weight and more preferably between 0.01 and 0.25% by weight.
The condensation catalyst, in relation to the total weight of the composition, is preferably contained in the composition in a proportion of between 0.001 and 1% by weight and more preferably between 0.01 and 0.5% by weight.
The hardening agent, in relation to the total weight of the composition, is preferably contained in the composition in a proportion of between 0.1 and 10% by weight and more preferably between 1 and 5% by weight.
The proportions of the components from which the composition is obtained are to be selected so that the total of the ranges selected comes to 100% by weight.
Preferably R¹ and R² of the polymer of the general formula 1 are selected independently of one another from the group containing methyl groups, ethyl groups, methoxy groups and ethoxy groups.

In a further preferred embodiment in the general formula 1 R¹ is a methyl group, R² is a methoxy group and n is 1.
Preferably R³, R⁴, R⁵ and R⁶ can be selected independently of one another from the group consisting of hydrogen, methyl groups and ethyl groups.
Preferably in each case m is 1, 2, 3 and/or 4 and/or o is a number between 1 and 100. In a preferred embodiment o is a number between 1 and 50, more preferably between 1 and 20 and particularly preferably 1, 2, 3, 4, 5, 6, 7, 8, 9, or 10.
It is further preferred that R³, R⁴ and R⁵ are hydrogen and R⁶ is a methyl group.
In a preferred embodiment the metal, the compound or the complex from the group of platinum metals is platinum or palladium or contains platinum or palladium.
Preferably metallic or finely distributed platinum, on a carrier such as silicon dioxide, aluminium oxide or activated charcoal is added to the composition. Compounds or complexes of platinum, such as platinum halides, e.g. PtCl₆, H₂PtCl₆.6H₂O, Na₂PtCl₄.4H₂O, platinum-olefin complexes, platinum-alcohol complexes, platinum-alcoholate complexes, platinum-ether complexes, platinum-aldehyde complexes, platinum-ketone complexes, including reaction products of H₂PtCl₆.6H₂O and cyclohexanone, platinum-vinyl siloxane complexes, such as platinum-1,3-divinyl-1,1,3,3-tetramethyl disiloxane complexes containing or not containing detectable inorganically bonded halogen, bis-(γ-picolin)-platinum dichloride, trimethylene-dipyridine-platinum dichloride, dicyclopentadiene-platinum dichloride, dimethylsulfoxide-ethylene-platinum-(II) dichloride, cyclooctadiene-platinum dichloride, norbornadiene-platinum dichloride, γ-picoline-platinum dichloride and/or cyclopentadiene-platinum dichloride can preferably be used.
The condensation catalyst, which is added to the composition, is preferably an organic compound of tin, zirconium, titanium and/or aluminium. These condensation catalysts preferably include butyl titanate and organic tin compounds, such as di-n-butyltin acetate, di-n-butyltin dilaurate and reaction products, at least two of the molecules of which are oxygen-bonded to silicon, if necessary by an alkoxy group-substituted, monovalent hydrocarbon residue containing silane or its oligomer with diorganotin diacetate as the hydrolysable groups, wherein in these reaction products all valencies of the tin atoms are saturated by oxygen atoms from the grouping —SiOSn— or by SnC-bonded, monovalent organic residues.
The hardening agent preferably results in the cross-linking of the composition. The hardening agent is preferably an alkoxysilane, which preferably has at least three alkoxy groups and/or its partial hydrolysate. A preferred alkoxysilane is vinyltrimethoxysilane or vinyltriethoxysilane. A partial hydrolysate is preferably obtained by hydrolysis and condensation of preferably between 2 and 4 alkoxysilanes. Partial hydro-lysates are for example hexamethoxydisiloxane and hexaethoxydisiloxane.
Preferably a filler is also added to the composition. The fillers can be selected from oxides or mixed oxides of metals and/or semi-metals. Fillers are preferred such as quartz, diatom earth, calcium silicate, zirconium silicate, zeolites, metal oxide powders, such as aluminium-, titanium-, iron-, or zinc oxides or the mixed oxides thereof, barium sulphate, calcium carbonate, gypsum, silicon nitride, silicon carbide, boron nitride, glass and synthetic material powders, such as polyacrylnitrile powder, reinforcing fillers, non-reinforcing fillers, such as pyrogenically produced silicic acid, precipitated silicic acid, soot, such as furnace or acetylene soot and silicon-aluminium mixed oxides with a large BET surface area and fibrous fillers such as asbestos and synthetic fibres.
The fillers mentioned can be rendered hydrophobic, for example by treatment with organosilane or siloxane, with stearic acid or by etherification of hydroxyl groups with alkoxy groups. One kind of filler, or a mixture of at least two fillers, can be added to the composition.
The filler, in relation to the total weight of the composition, is preferably contained in a proportion of between 1 and 80% by weight, preferably of between 5 and 70% by weight and more preferably of between 10 and 60% by weight in the composition.
In a further preferred embodiment a plasticiser is added to the composition. As the plasticiser all plasticisers can be used that will be familiar to a person skilled in the art. In particular plasticisers such as dimethylpolysiloxanes or phosphoric acid esters which are fluid at room temperature and which are end-blocked by trimethylsiloxy groups can be added. Particular preference is for alkylaryl phosphates which are added as plasticisers. In a further preferred embodiment the plasticiser is selected from the group consisting of benzyl phthalate esters, dibenzoate esters, phosphate esters, polymeric adipinic acid esters and mixtures of these. Particular preference is for butyl benzyl phthalate, alkyl (C7-C9)benzyl phthalate, texanol benzyl phthalate, modified benzyl phthalate, dipropylene glycol dibenzoate, modified dibenzoate, benzyl phthalate, dipropylene glycol/diethylene glycol dibenzoate, 2-ethyl hexyl mono-benzoate, octyl diphenyl phosphate, isodecyl diphenyl phosphate, alkyl(C12-C16)aryl phosphate, poly(1,3-butane/1,2-propandiol)adipate, poly(neo-pentane/1,2-propandiol)adipate, poly(1,3-butane)adipate, poly(neo-pentane/butandiol)adipate, poly(1,2-propandiol)adipate/phthalate and mixtures of these as plasticisers.
The plasticiser, in relation to the total weight of the composition, is preferably contained in a proportion of between 0.1 and 30% by weight, preferably of between 5 and 25% by weight and more preferably of between 1 and 15% by weight in the composition.
Depending on the mixing process, it is preferred to add the plasticiser to the composition before any homogenisation and/or after any homogenisation.
More preferably bonding agents are added to the composition. The bonding agents are preferably alkoxysilanos, aminosilanes and/or alkoxyaminosilanes, which in addition to alkoxy groups and/or amino groups comprise residues selected from the group consisting of hydrogen atoms, SiC-bonded hydrocarbon residues, as well as SiC-bonded substituted hydrocarbon residues, as well as mixtures of these and partial or mixed hydrolysates. Preference is for alkoxy groups with between 1 and 6 carbon atoms, in particular methoxy-, ethoxy- and propoxy groups. For the hydrocarbon residues alkyl and alkenyl residues, and in particular the vinyl- and 2-propynyl residues are preferred. The hydrocarbon residue is preferably a hydrocarbon residue with between 1 and 18 carbon atoms, which are optionally substituted with epoxy, (poly)glycol- or acid anhydride residues or residues of the formula —O(CO)—R⁷, where R⁷ is a hydrogen atom or hydrocarbon residue.

The bonding agent, in relation to the total weight of the composition, is preferably contained in a proportion of between 0.1 and 10% by weight and more preferably of between 1 and 5% by weight in the composition.

Depending on the mixing process, it may be preferable to add the bonding agent to the composition before any homogenisation and/or after any homogenisation.
Preferably all the ingredients of the composition are dried before mixing. in a further preferred embodiment essentially anhydrous or anhydrous ingredients are used for producing the composition.

Surprisingly the composition of the present invention demonstrates very good flame retardance. The flame retardance can be determined in accordance with DIN 4102 in the fire test vertical shaft. The improved flame retardance is probably achieved, although this is not offered as a hard and fast theory, by the combination of the metal selected from the to group of platinum metals and the condensation catalyst. Compositions which do not contain the combination of the two substances demonstrate a significantly greater flammability and are unsuitable for use in areas in which flame retardant sealing materials are called for.

A further aspect of the present invention is a method for producing the above-mentioned composition containing the following steps:
a) preparation of a polymer of general formula 1

R¹ₙR²₃₋ₙSi(CR³R⁴)ₘ—(O—CR³R⁴—CR⁵R⁶)ₒ—O—(CR³R⁴)ₘSiR¹ₙR²₃₋ₙ (1),
where
R¹ and R² are selected independently of one another from the group consisting of alkyl groups with between 1 and 8 carbon atoms and alkyloxy groups with between 1 and 8 carbon atoms,
n is a number between 0 and 3,
R³, R⁴, R⁵ and R⁶ are selected independently of one another from the group consisting of hydrogen and alkyl groups with between 1 and 8 carbon atoms,
m is a number between 0 and 10 and
o is a number between 1 and 1,000,
where the polymer of general formula 1 has optionally been modified with acrylic acid,
b) addition of a metal, a compound or a complex from the group of platinum metals,
c) addition of a condensation catalyst, and
d) addition of a hardening agent.

In a preferred inventive method after step b) homogenisation takes place, preferably in the manner indicated above.

Preferably R¹ and R² of the polymer of general formula 1 are selected independently of one another from the group consisting of methyl groups, ethyl groups, methoxy groups and ethoxy groups,

More preferably R¹ is a methyl group and R² is a methoxy group, wherein n is 1.

In a preferred embodiment R³, R⁴, R⁵ and R⁶ are selected independently of one another from the group consisting of hydrogen, methyl groups and ethyl groups. It is further preferred that in each case m is 1, 2, 3 and/or 4 and o is a number between 1 and 100.

Preferably R³, R⁴ and R⁵ are hydrogen and R⁶ is a methyl group.

The metal used is preferably platinum or palladium, wherein the abovementioned specific metal compounds can preferably be used.

The condensation catalyst is also preferably an organic compound of tin, zirconium, titanium and/or aluminium. The abovementioned condensation catalysts can preferably be used.

For the hardening agent to be used, that stated above on this ingredient applies by analogy.

Fillers, plasticisers and/or bonding agents can optionally be used in the method.

Part of the invention is obviously also a composition which can be produced according to an inventive method. Likewise part of the invention is the use of an inventive composition as a sealant, bonding agent and/or plugging agent.

As already explained above, the inventive compositions demonstrate a pronounced flame retardance. The flame retardance can be determined in a test of the behaviour in fire in accordance with DIN 4102-1: 1998-05. By way of reference this standard is a component part of the present application. Accordingly, preferred inventive mixtures have flame retardance determined in accordance with the stated standard. Here it transpires that the homogenisation described above following addition of a metal, a compound or a complex from the group of platinum metals has a positive effect on the level of flame retardance. The combination of a metal, a compound or a complex from the group of platinum metals with a condensation catalyst appears to have a positive effect on the flame retardance. Compositions which do not contain a combination of the last two substance groups mentioned demonstrate a significantly higher flammability and are unsuitable for use in areas in which flame retardant sealing materials are called for. Here it transpired that it was preferable for a homogenisation as described above to take place before the condensation catalyst and/or the hardening agent was added to the composition.

### EXAMPLE 1

### Production of a Sealing Mass

20.00 g of dried Al(OH)₃ (Martinal OI-104), 0.80 g of dried TiO₂, 2.20 g polyamide wax (Crayvallac), 9.00 g polymer S303H (Kaneka Corp., corresponding to a polymer according to the general formula 1 of the present application) and 6.70 g of an alkylaryl phosphate (plasticiser) are mixed. Then 0.20 g aminopropyltrimethoxysilane (Silan A1110), 0.20 Pt-Kat512 (Hansechemie, Hamburg), 0.060 g vinyltrimethoxysilane (hardening agent[)] and 0.40 g dibutyltin diketanoate (TEGOKAT 226, Goldschmidt) are added to the mixture. The composition obtained is mixed homogenously, in order to obtain a sealing composition.

After hardening the sealing composition obtained demonstrates a very good flame retardance. According to DIN 4102-1: 1998-05 the flame retardance in the fire test vertical shaft is adequate.

The sealing properties of the sealing composition are also comparable with the sealing compositions of the state of the art.

### EXAMPLE 2

### Production of a Large Quantity of a Sealing Mass

250 kg of dried Al(OH)₃ (Martinal OL-104, supplied by Brenntag of Vienna), 10 kg of dried TiO₂ and 27.5 kg of polyamide wax (Crayvallac, supplied by Biesterfeld of Vienna) were mixed until homogenous. Then 115 kg of polymer S303H (Kaneka Corp., corresponding to a polymer according to the general formula 1 of the present invention) and 100 kg of a plasticiser (Disflamoll DPK, Alkyl-Aryl-Phosphat, Lanxess) were mixed, in with 60° C. being maintained for 10 minutes.

Then 1.5 kg of aminopropyltrimethoxysilane (Silan A1110, supplied by SWOP-Chemie, Berchtoidsdorf) and 3 kg platinum catalyst (Pt-Kat512, Hansechemie, Hamburg) were added. The mixture was left to stand for 24 hours at ambient temperature in order to homogenise. Then 10 kg of vinyltrimethoxysilane (VTMO, supplied by Momentiv, Leverkusen) and 2 kg of dibutyltin diketanoate (TEGOKAT 226, from Goldschmidt, Mannheim) were added.

### EXAMPLE 3

A sealing mass was produced similarly to Example 2, but in this case addition of the platinum catalyst was dispensed with.

### EXAMPLE 4

Comparison of the flammability of the sealing masses produced in Example 2 and Example 3.

Following ignition the sealing masses produced in Example 3 burned away without self-extinguishing, while the sealing masses produced in accordance with Example 2 demonstrated faster self-extinguishing.

### EXAMPLE 5

### Testing of the Sealing Mass Produced in Accordance with Example 2

The sealing mass produced in accordance with Example 2 was subjected to fire testing, unless otherwise indicated in accordance with DIN 4102-1: 1998-05.

### A) Testing in the Combustion Box

The fire test took place in accordance with DIN 4102-1 Section 6.2.5. Five edge inflammations in accordance with Section 6.2.5.2 (samples No's 1 to 5) and five surface inflammations in accordance with section 6.2.5.3 (samples No's 6 to 10) were carried out. The test results are shown in the following table:

TABLE 1

| | | Edge inflammation | | | | | Surface inflammation | | | | |
|---|---|---|---|---|---|---|---|---|---|---|---|
| Sample No | | 1 | 2 | 3 | 4 | 5 | 6 | 7 | 8 | 9 | 10 |
| Time to inflammation | s | 0.5 | 0.4 | 0.4 | 0.4 | 0.4 | 1.9 | 2.4 | 2.0 | 1.4 | 2.0 |
| after start of ignition | | | | | | | | | | | |
| Duration of burning of | s | 15.3 | 15.7 | 15.4 | 15.3 | 15.8 | 13.7 | 12.9 | 14.0 | 14.2 | 13.2 |
| self-generated flames | | | | | | | | | | | |
| Maximum height of self- | mm | 20 | 20 | 20 | 20 | 20 | 20 | 20 | 20 | 20 | 20 |
| generated flames | | | | | | | | | | | |

| | |
|---|---|
| Smoke development | slight |
| Burning falling | no |
| material/drops | |

### B) Fire Test in Vertical Shaft

A joint sealing mass was inserted in a 15 mm wide joint between two fibre cement beams and ground off flush with the beams. The joint depth was 10 mm. Four samples prepared in this way each provided a test piece for the fire testing in the vertical shaft. The test results are contained in the following table.

TABLE 2

| Test piece | | A | B | C |
|---|---|---|---|---|
| Joint width | mm | 15 | 15 | 15 |
| Joint depth | mm | 10 | 10 | 10 |
| Maximum flame height | cm | 60 | 40 | 40 |
| Time after test start | min:s | 08:49 | 04:17 | 06:35 |
| Melting through or burning | min:s | — | — | — |
| through after test start | | | | |
| Flames on the rear side of | | — | — | — |
| the test piece after test start | | | | |
| Burning drops or falling material | | No | No | No |
| Residual lengths; | | | | |
| Individual values | cm | 45 | 60 | 60 |
| | cm | 47 | 56 | 58 |
| | cm | 45 | 57 | 58 |
| | cm | 45 | 58 | 60 |
| Mean | cm | 46 | 58 | 59 |
| Overall average | cm | 54 | | |
| Maximum flue gas temperature | ° C. | 109 | 118 | 119 |
| After test start | min:s | 09:57 | 09:31 | 09:47 |
| After-burning after test end | min:s | — | — | — |
| After-glow after test end | min:s | — | — | — |
| Smoke development | | | | |
| Maximum reduction in light intensity | % | 4 | 7 | 1 |
| Integral value I | min* % | 18 | 7 | 1 |

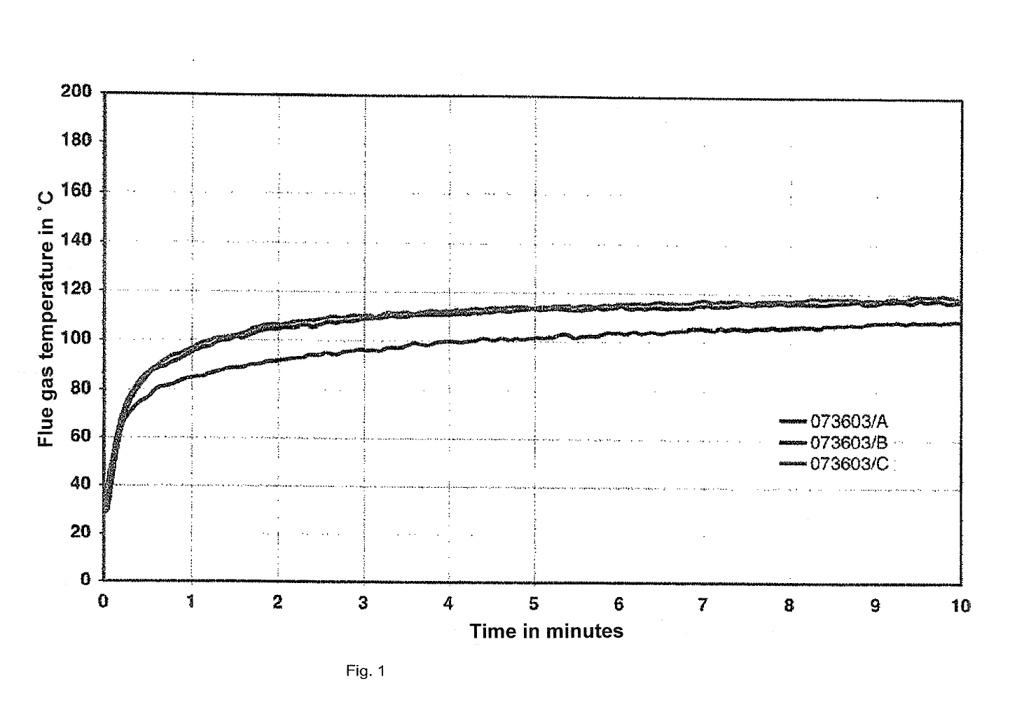

The development of the flue gas temperatures is shown in FIG. 1.

The integral values

$$I {\int }_{0}^{10 min} S * d t$$

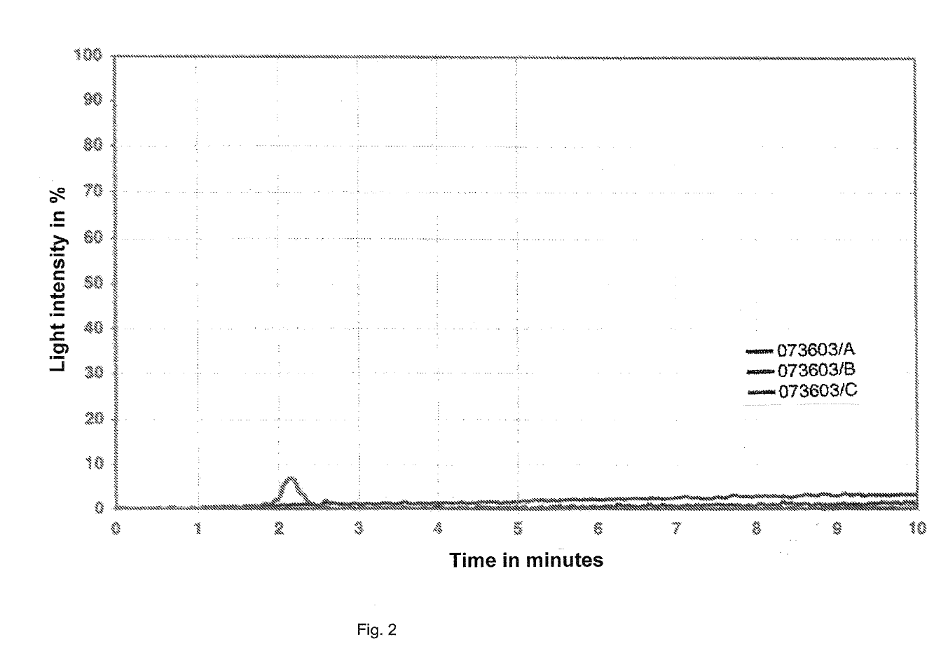

were determined from the reduction in light intensity curves shown in FIG. 2.

FIG. 1 shows the development of the flue gas temperature.

FIG. 2 shows the development of the reduction in light intensity.

The test results are summarised below in Table 3:

TABLE 3

| | | |
|---|---|---|
| Apparent density | kg/m³ | 1530 |

Fire test in vertical shaft

| | | |
|---|---|---|
| Maximum flame height | cm | 60 |
| Average residual iength | cm | 54 |
| Maximum flue gas temperature | ° C. | 119 |
| Burning falling drops/material | | No |
| Maximum reduction in light intensity | % | 7 |
| Integral value | min* % | 7 |

Combustion box test

| | | |
|---|---|---|
| Maximum flame height | mm | 20 |
| Burning falling drops/material | | No |

### Result:

The sealing mass produced in accordance with Example 2 meets the requirements of construction material class B1 (fire-retardant) in accordance with DIN 4102-1: 1998-05. The sealing mass is classed in accordance with DIN 4102-16: 1998-05 as not producing burning falling drops/material.

1. Composition which is obtained by mixing
a) a polymer of the general formula 1
R¹ₙR²₃₋ₙSi(CR³R⁴)ₘ—(O—CR³R⁴—CR⁵R⁶)ₒ—O—(CR³R⁴)ₘSiR¹ₙR²₃₋ₙ (1),
where
R¹ and R² are selected independently of one another from the group consisting of alkyl groups with between 1 and 8 carbon atoms and alkyloxy groups with between 1 and 8 carbon atoms,
n is a number between 0 and 3,
R³, R⁴, R⁵ and R⁶ are selected independently of one another from the group consisting of hydrogen and alkyl groups with between 1 and 8 carbon atoms,
m is a number between 0 and 10 and
o is a number between 1 and 1,000,
where the polymer of general formula 1 has preferably been modified with acrylic acid,
b) a metal, a compound or a complex from the group of platinum metals,
c) a condensation catalyst, and
d) a hardening agent,
wherein the composition is obtained (i) through the addition of further components or (ii) without the addition of components.

2. Composition according to claim 1, wherein R¹ and R² of the polymer of general formula 1 are selected independently of one another from the group consisting of methyl groups, ethyl groups, methoxy groups and ethoxy groups.

3. Composition according to claim 1, wherein R¹ is a methyl group, R² is a methoxy group and n is 1.

4. Composition according to claim 1, wherein R³, R⁴, R⁵ and R⁶ are selected independently of one another from the group consisting of hydrogen, methyl groups and ethyl groups.

5. Composition according to claim 1, wherein m in each case is 1, 2, 3 and/or 4 and for o is a number between 1 and 100.

6. Composition according to claim 1, wherein R³, R⁴ and R⁵ are hydrogen and R⁶ is a methyl group.

7. Composition according to claim 1, wherein the metal is platinum or palladium.

8. Composition according to claim 1, wherein the condensation catalyst is an organic compound of tin, zirconium, titanium and/or aluminium.

9. Composition according to claim 1, wherein the hardening agent is an alkoxysilane having at least three alkoxy groups and/or the partial hydrolysate thereof.

10. Composition according to claim 1, wherein the composition contains comprises a filler.

11. Composition according to claim 1, wherein the composition comprises a plasticiser.

12. Composition according to claim 1, wherein the composition comprises a bonding agent.

13. Method for producing a composition comprising:
a) preparing a polymer of general formula 1
R¹ₙR²₃₋ₙSi(CR³R⁴)ₘ—(O—CR³R⁴—CR⁵R⁶)ₒ—O—(CR³R⁴)ₘSiR¹ₙR²₃₋ₙ (1),
where
R¹ and R² are selected independently of one another from the group consisting of alkyl groups with between 1 and 8 carbon atoms and alkyloxy groups with between 1 and 8 carbon atoms,
n is a number between 0 and 3,
R³, R⁴, R³ and R⁶ are selected independently of one another from the group consisting of hydrogen and alkyl groups with between 1 and 8 carbon atoms,
m is a number between 0 and 10 and
o is a number between 1 and 1,000,
where the polymer of general formula 1 has optionally been modified with acrylic acid, and
e) adding a metal, a compound or a complex from the group of platinum metals,
f) adding a condensation catalyst, and
g) adding a hardening agent.

14. Method according to claim 13, wherein R¹ and R² of the polymer of general formula 1 are selected independently of one another from the group consisting of methyl groups, ethyl groups, methoxy groups and ethoxy groups.

15. Method according to claim 13, wherein R¹ is a methyl group, R² is a methoxy group and n is 1.

16. Method according to claim 13, wherein R³, R⁴, R⁵ and R⁶ are selected independently of one another from the group consisting of hydrogen, methyl groups and ethyl groups.

17. Method according to claim 13, wherein m in each case is 1, 2, 3 and/or 4 and/or o is a number between 1 and 100.

18. Method according to claim 13, wherein R³, R⁴ and R⁵ are hydrogen and R⁶ is a methyl group.

19. Method according to claim 13, wherein the metal is platinum or palladium.

20. Method according to claim 13, wherein the condensation catalyst is an organic compound of tin, zirconium, titanium and/or aluminium.

21. Method according to claim 13, wherein the hardening agent is an alkoxysilane preferably having at least three alkoxy groups and/or the partial hydrolysate thereof.

22. Method according to claim 13, wherein a filler is added.

23. Method according to claim 13, wherein a plasticiser is added.

24. Method according to claim 13, wherein a bonding agent is added.

25. Composition obtained in accordance with a method according to claim 13.

26. (canceled)

27. Method of sealing, adhering or plugging, comprising:
applying a composition according to claim 1 to a substrate.
